(19) United States
(12) Patent Application Publication
(10) Pub. No.: US 2014/0278789 A1
(43) Pub. Date: Sep. 18, 2014

(54) System and method for business entities to receive product and brand related customer input and other data.

(71) Applicants: Gurpreet Singh, Toronto (CA); Weiheng Xu, Singapore (SG)

(72) Inventors: Gurpreet Singh, Toronto (CA); Weiheng Xu, Singapore (SG)

(73) Assignee: GTAG TECHNOLOGIES INCORPORATED, Toronto (CA)

(21) Appl. No.: 14/207,715

(22) Filed: Mar. 13, 2014

Related U.S. Application Data
(60) Provisional application No. 61/782,813, filed on Mar. 14, 2013.

(51) Int. Cl. G06Q 30/02

(52) U.S. Cl. CPC G06Q 30/0203; G06Q 30/0205; G06Q 30/0217
USPC 705/7.32

(57) ABSTRACT

A system and method for business entities to solicit product and brand related feedback from the authenticated customers through use of browser run feedback application on the internet enabled mobile devices of customers, where customer opts to wirelessly connect their mobile device with the feedback software and the software: captures customer location; verifies customers as genuine user of products; initiates the feedback session; presents the identification and feedback forms to the mobile device; captures and relays the feedback data to the business in real-time; and offers reward coupon to the customer after successful submission of the feedback form. System includes custom tags encoded with product information and embedded in the product and related paraphernalia. Geographical co-ordinates and personal information obtained from participants are plotted on a grid or a map to provide macro analysis and micro analysis to businesses.

### TECHNICAL FIELD

The present disclosure relates generally to business-customer communication using wireless and other computerized communication devices and, more particularly, to a system and method that enables business entities to receive authenticated customer suggestions, feedback and consultancy through an internet connected mobile or wireless devices.

### BACKGROUND

For business entities, customer feedback and profiles are important tools to conduct market segmentation, targeting and positioning. The customer feedback and profiles are also required to gauge product performance and the reasons thereof, improve the current products, design new products with relevant features, and determine the market demand and market price for current and future products. Traditionally, business entities have relied on market research firms to conduct polls, surveys and focus groups to collect the customer information. A major drawback of this approach is that these market research methods either require considerable investment and time or are too focused on only a particular customer segment or a region.

Tracking product performance after the market launch is trickier. One of the lagging indicators of product performance is change in the demand of the product. This change in demand may be geographical region specific or widespread. If the demand change is not per the expectations, product is considered to be underperforming. Although, businesses can conduct a market study to find the underlying reasons, short product lifecycles mean that results may not be received in time for any meaningful modifications to be applied to the product.

A relatively newer method of consumer research is the use of region specific online search engine data to predict the demand for a product in the region. Although inexpensive, it relies on the capture of most commonly searched words or phrases on the online search engines like Google, Bing and Yahoo. With strict privacy requirements imposed by regulatory authorities and do-not-track browser option employed by customers, it is difficult to differentiate multiple searches conducted by same customer from searches conducted by multiple customers. Additionally, demographic information may not be captured through this method due to privacy restrictions. Thus, this method may not accurately reflect the needs of customers.

Direct communication with customers to determine their needs is considered superior to methods that rely on sampling or indirect data collection. Advent of social media has provided business entities a channel to collectively engage customers and solicit their feedback in an inexpensive way. But Social Media tools have not solved the many issues. First and foremost, the customer feedback received is not authenticated. There is no reliable way to determine if feedback provider is product user or not. Secondly, the customer feedback using social media does not offer location where the customer bought and consumed the product or brand except in the case of public consumption like dine-in restaurants. Thirdly, the consumer feedback is not relayed to business entities in real time. Business entities may have to collect feedback manually or utilize costly third party tools. Precious time and resources are consumed in this operation. Lastly, the customer feedback using social media tools is not private and hence some customers are unwilling to give feedback.

As can be seen, there is a need for business entities to receive real-time, location specific and sometime private feedback from large number of authenticated customers in a cost-effective manner. These needs are satisfied by the present invention.

### SUMMARY

Present invention provides a method for business entities, following either business to business (B2B) or business to consumer (B2C) model including but not limited to product manufacturers, wholesalers, retailers, marketers or any other business stakeholders that manufacture and/or market products or brands to receive authenticated customer comments, suggestions, feedback and consultancy from consumers or customers through an internet connected mobile or wireless devices.

In the method, customers can upgrade into a remote product and/or brand consultant for the business entity by registering. Customer details such as but not limited to the residence location information may be needed by the business entity to perform this operation. A unique identifier may be used for differentiating a consultant from an unregistered feedback provider.

In the method, aggregate geographic customer concentration based on actual location of the product consumption can be determined. Geographic customer concentration is calculated by determining longitude and latitude of product consumption location and mapping these coordinates in a tabular or graphical representations.

Further, present invention provides a system for feedback solicitation. System described constitutes of: (a) software applications that are executed in part on mobile browsers of customer and partially on the remote located computing systems, (b) apparatus that contains information for the customer on how to provide feedback and connect with the feedback software.

This Summary is provided to introduce a selection of concepts in a simplified form that are further described in the Detailed Description section. Summary is not intended to identify key features or essential features of the claimed subject matter, nor is it intended to be used to limit the scope of the claimed subject matter.

### BRIEF DESCRIPTION OF THE DRAWINGS

Detailed description in conjunction with the accompanying drawings will provide a complete understanding of present invention wherein:

FIG. 1 is a flowchart that illustrates the basic steps of a method for business entities to solicit customer feedback and consumption location information about products or brands sold in shopping centres by company owned shops, third party retailing shops or even online;

FIG. 2 is a block diagram that illustrates the basic components of a system the business entities employ to receive customer feedback and consumption location information in accordance with embodiment of the present invention;

FIGS. 3A-3C are block diagrams of example mobile devices used by customer to provide feedback and the respective custom tags encoded with information that can be deciphered by mobile devices of customers as deployed on the product;

FIG. 3D is block diagram of an embodiment of a product with custom tag containing multiple tags encoded with information that can be deciphered by mobile devices of customers;

FIG. 4 is block diagram of an embodiment of customer density map displaying customer density in a residential area based on location data provided by customers;

FIG. 5 is flowchart that illustrates the basic steps of a method which business entities may employ to additionally reward customers who provide useful feedback in accordance with an embodiment of the present invention;

FIG. 6 is a flowchart that illustrates the basic steps of a method which business may employ to make customer feedback comments available for public view in accordance with another embodiment of the present invention;

### DETAILED DESCRIPTION

Direct customer feedback is very important for business entities engaged in manufacturing, selling or marketing of products. It allows business entities to understand product requirements, add features to the products and design new products. Feedback also helps in determining the aggregate product demand and set product pricing. Besides direct customer feedback, other customer information obtained indirectly like consumption location and patterns are very useful in determining aforementioned. All this information is only valid and useful if obtained from an authenticated or genuine customer. Various embodiments of the current invention enable business entities to solicit customer feedback and other useful information from authenticated customers. Further, density map feature of the current invention allows raw information to be depicted in a graphical or a tabular way making information very easy to comprehend for business decision makers.

FIG. 1 illustrates a flowchart 100 of the basic steps of the method for the business entities to solicit customer feedback and consumption location information about their products and/or brands sold in shopping centres by company owned shops, third party retailing shops or online, and businesses to receive above data in unprocessed and processed form.

In step 1 of the flowchart 100, business entity subscribes to the feedback plan from the company handling the feedback software and the apparatus. A custom tag is generated and embedded with uniform resource locator (URL). This URL contains the product information including but not limited to product name, Universal Product Code, International Article Number, product code, batch code and a sale location. URL contains the product information as GET variables.

In another embodiment, URL directs the feedback software to a remote server location where a file designed to carry data file like XML is stored with the product information mentioned in [0022]. This embodiment is suitable for situations where product information is updated frequently. Business entities may be provided with key to remote server location and authentication server to update the product information. In some embodiments, this process may be automated through a prior determined algorithm.

In step 2 of the flowchart 100, business receives the custom tags encoded or embedded with URL depending on the type of custom tags. Custom tag can take form of including but not limited to Quick Response (QR) Code, a near field communication (NFC) chip or a shortened URL.

In step 3 of the flowchart 100, business entity, depending on the nature of custom tags, embeds or prints the custom tags in/on the product packaging and/or the accompanying manual. It is important that tags are visible and accessible to the customers. An appropriate message can be added by business entity inviting customers to use their internet mobile device to extract the URL information and provide feedback and other information as requested.

In step 4 of the flowchart 100, customer with the internet connected mobile device uses a third party application to extract URL from custom tag on the product. Third party application feeds this URL to the browser of the mobile device. Browser may be any compatible browser for the mobile devices including but not limited to Android browser, Safari browser and Mozilla Firefox browser. A handshake between mobile device and feedback software application is offered over browser of the mobile device. A unique session token that persists through the feedback session is generated by the authentication server. Session token is time sensitive and allows customer to connect to the feedback server for a limited period of time also known as session. The feedback application extracts the product information embedded in the URL or by reading the file designed to carry data stored in a remote server location pointed to by the URL as described in [0023]. Further, the feedback application determines the current location of the mobile device using; the Internet Protocol (IP) address database wherein network addresses as linked to specific postal addresses or latitude/longitude coordinates are stored; cell-tower or WiFi antenna triangulation; cell-tower or WiFi antenna proximity or signal strength and/or other appropriate techniques. The determination of location information will depend upon the privacy requirements and permissions provided by the customer.

In step 5 of the flowchart 100, the product information and the location information extracted in step 4 is forwarded to the authentication server that compares the extracted information with the information stored in the database of the authentication server. Results of match are categorized as: (a) Full match of product and location information (b) Product Information matches but location information does not match. This condition can result from customer not providing location information or the location information of consumption is not within a specified distance from the product sale location (c) No match for product information. If condition (a) is met, the feedback is tagged as fully authenticated. If condition (b) is met, the feedback is tagged as partially authentic. If condition (c) is met, the session is terminated and an appropriate message is displayed on the customer's mobile device. It is to be noted that browser may or may not request permission from customer for sharing the location data depending upon the settings of the browser. If location data in not shared then condition (a) can never be met. An incentive for customers to share their location will increase customer participation and in turn increase the usefulness of the feedback.

In another embodiment, the authentication server is connected with the inventory management system of the retailers and status of product batch updated in real-time. An attempt to scan or tap custom tags on products before purchase will return negative on check with retailer inventory management system while a positive return will indicate that the product has already been purchased by the customer. This information be used for customer authentication and/or can be tagged to feedback provided.

In step 6 of the flowchart 100, the mobile device is connected to the feedback server conditional upon successful completion of the authentication in step 5 as described in [0027] and [0028]. Feedback server generates the identification and feedback forms and offers them as mobile optimized web pages to the customer during this session. The identification page provides customer option to identify as an unregistered customer or a registered customer. Customers can read the feedback instructions, provide contact information, add comments or the feedback, and submit the content to feedback server during the life of the session utilizing the mobile device. If session is timed out or connection with the server is lost, customer will have to reinstate the connection with feedback server. Feedback server may limit the number of connection attempts by same mobile device during a certain time interval to deter malicious users.

In step 7 of the flowchart 100, customer is given option to login as a consultant if previously registered, register as a consultant or provides anonymous feedback. Customer may decide to share his/her contact details in feedback form which business entity can use to contact the customer to conduct a more thorough analysis. Unregistered customers may also decide to leave contact information blank to submit feedback anonymously.

Customer can upgrade into a remote product and/or brand consultant for the business entity by registering. Registration process requires customer to provide and verify personal information. Personal information may include but is not limited to name, contact information, residence location and personal preferences. A unique identifier is assigned to each registered consultant, to be used for differentiating a consultant from a general feedback provider. Registered customers prove their identity during subsequent feedback sessions by utilizing one or more of the following methods (a) providing unique identifier assigned during registration, (b) using single sign-on using third-party application programming interface for login set up during registration, and (c) using integrated login of existing third-party application set up during registration.

In an embodiment, business entities may assign a reputation rating to registered consultants, wherein the reputation rating is function of completeness of personal information profile, feedback history and usefulness of feedback as inferred by business management. Feedback history, in turn, constitutes of product information as extracted from custom tag of the product during each feedback session, results of the product and/or sale location verification conducted by authentication server during each feedback session, feedback location coordinates as captured during the feedback session and feedback in the form of answers to the questions in the feedback form of feedback software module.

In step 8 of the flowchart 100, successful submission of feedback within allowed session results in customer being redirected to a rewards server. Rewards server generates a reward coupon and displays it on the browser of mobile device as a mobile optimized web page. Coupon may be time stamped for use within limited time period. This process is automated and rewards are predetermined.

In step 9 of the flowchart 100, the map server is updated with the geographical coordinates obtained earlier. The map server uses this information and other demographic data to plot customer geographic market densities in various tabular and chart formats for a particular product or brand worldwide. Thematic maps created using methods like dot distribution, contour lines, cloropeth maps or any other appropriate method like 3D mapping techniques may be used as density maps. The density maps can be utilized by business entities to quickly identify changing needs of customers without involving third parties. For example, a rapidly growing customer base in an area or locality may elicit a need for establishing a newer retail location in that area or procuring shelf space with local retailer for offering the products.

In step 10 of the flowchart 100, the feedback data stored in feedback server and map data stored in map server is processed and relayed to a dashboard in real-time. Feedback may also be forwarded to a web or mobile device of the business manager in form of email or any appropriate message format.

In another embodiment, the customer feedback is analyzed using a statistical method like conjoint analysis to determine the value that customer places on different features which make up a product or brand and hence determine the market price for a product or brand.

FIG. 2 illustrates a block diagram 200 with the basic components of a system for business entities to receive product and brand related customer input and other data in accordance with embodiment of the present invention.

10 of the block diagram 200 represents product packaging and/or accompanying brochure with custom tags 12 that are encoded with a URL. Scanning or tapping the custom tags initiate a connection between an internet connected mobile device and feedback software.

13 of the block diagram 200 represent a mobile terminal used by the customers to connect with feedback software. It may represent any mobile phone or tablet with Android, iOS, Windows or any other suitable operating system. This mobile terminal is capable of connecting with a network using 3G cellular communication system, a wireless local area network (WLAN) or any other appropriate wireless communication system capable of sending and receiving data. 14 represents network access provided to mobile terminal using any of the above methods. This network access is required for feedback software to connect with mobile device. Mobile terminals depicted by 13 are able to decode URL information encoded in custom tags.

15 of the block diagram 200 represent all-encompassing feedback software. It handles the requests from customer to connect the mobile terminal; extracts and interprets information encoded in the custom tag 12 of the product 11; initiates a browser session using a session token generated by the authentication server 16; determines the current location of the mobile terminal 13; provides the product information and mobile terminal location to the authentication server 16 for the verification of customer's product purchase; presents the optimized identification page generated by feedback server 20 to the mobile device; presents appropriate feedback page generated by a feedback server to the mobile device dependent on the identification option selected by customer in previous step; captures the feedback data entered by customer and stores it in feedback server 20; offers reward coupon generated by the rewards server 21 to the customer upon successful submission of the feedback form; updates the location map stored in the map server 18 using the geographical coordinates obtained in earlier step; processes and relays the feedback data stored in feedback server 20 and map data stored in map server 18 to a dashboard in real-time; and displays the relayed data in graphical format on the dashboard. Arrows in the illustration 200 depict the flow of information. Authentication server, feedback server, map server and rewards server comprise of computer software programs capable of reading, analysing and updating databases that run on networked computers hosted in the business premises or on the networked remote computer systems hosted on the cloud system.

17 of the block diagram 200 represents an analytics tool capable of conducting in depth analysis of the feedback for reasons that include but not limited to market research and improving customer loyalty. In an embodiment of the invention, a customer relationship management (CRM) system 19 can be integrated into the system to organize and synchronize business functions like but not limited to sales, marketing, and customer service.

22 of the block diagram 200 represents computing device used by business entity to receive feedback in real-time. It may be a mobile phone, a tablet or a personal computer with network access 14. The feedback may be received in form of dashboard generated by feedback software 15 in form of webpage, an email or message that can be optimally displayed on the device.

FIG. 3A illustrates an embodiment of a mobile terminal 23 that can extract URL information from QR code and an example product with QR code based custom tag. Diagram 300A depicts front of the mobile terminal with screen 24, a front camera 26 and a QR code reader app 25. Diagram 300B depicts back of the mobile terminal with a back camera 27 and hardware 28 used to wirelessly connect with a network 14 as shown in FIG. 2. QR code reader app uses one of the cameras to scan QR code and extract URL information. Diagram 300C depicts an example product 29 with printed QR code 30 encoded with the URL that contains the product information or points to the remotely stored file containing the product information.

FIG. 3B illustrates an embodiment of a mobile terminal 31 that can extract URL information from NFC chip and an example product with NFC chip based custom tag. Diagram 400A depicts front of the mobile terminal with screen 32 and a NFC reader app 33. Diagram 400B depicts back of the mobile terminal with NFC chip reader hardware 35 and hardware 34 used to wirelessly connect with a network 14 as shown in FIG. 2. NFC reader app uses the NFC chip reader hardware to extract URL from NFC chip. Diagram 400C depicts an example product 36 embedded with a pre-programmed NFC chip 37 encoded with the URL that contains the product information or points to the remotely stored file containing the product information.

FIG. 3C illustrates an embodiment of a mobile terminal 38 that can extract URL information from printed text and an example product with printed text based custom tag. Diagram 500A depicts front of the mobile terminal with screen 39 and an optical character recognition app 40. Diagram 500B depicts back of the mobile terminal with a back camera 41 and hardware 42 used to wirelessly connect with a network 14 as shown in FIG. 2. Optical character recognition uses one of the cameras to scan an image with text and extract URL information. Diagram 500C depicts an example product 43 with printed shortened URL 44 that redirects customer to a URL containing the product information or points to the remotely stored file containing the product information.

FIG. 3D illustrates an embodiment of product with custom tag that comprises of multiple tags. Multiple tags can be used in conjugation to add additional layer of authentication or individually to provide customers multiple options to access the feedback module. Diagram 600 depicts an example product 45 with printed QR code based custom tag 46 and printed shortened URL based custom tag 47.

FIG. 4 illustrates an embodiment of customer density map generated by the map server 18 of FIG. 2. Block diagram 700 depicts a residential area and two shopping plazas in the areas. Top represents north, right represents east, bottom represents south, and left represents west. Density Map concept is used here to graphically display availability, consumption and demand of a hypothetical product called VVoily. VVoily is available in Shopping Plaza A 52 in South-West but not in Shopping Plaza B 48 in North. The residential blocks are categorized based on demand (density of customers) for VVoily: residential blocks with low product demand 49, residential blocks with medium product demand 50, and residential blocks with high product demand 51 as depicted by legend. Density of customers is determined based on number of feedbacks from each residential block as deciphered by correlating the location coordinates with residential blocks. An immediate conclusion from the density map is that a huge population segment located in North-Eastern area consumes VVoily. This segment will benefit if the product VVoily is also available at Shopping Plaza B 48 in North which is closer to their residences.

FIG. 5 illustrates an embodiment 800 of method 100 as illustrated in FIG. 1. In this embodiment, additional steps of allowing business entity to further reward customers and remote consultants if business entity finds the feedback useful are incorporated. A second reward coupon can be sent conditional upon customer choosing to provide contact information along with the permission to contact or choose to register as remote consultant. In step 53, business entity analyses the feedback using analysis software and other tools to determine its usefulness. In step 54, business entity rewards the feedback provider with a second reward coupon by sending to customer using an email, messaging program, short messaging service (SMS) or any other appropriate tool.

FIG. 6 illustrates another embodiment 900 of method 100 as illustrated in FIG. 1. In this embodiment, additional steps of allowing businesses to link the feedback dashboard to social media and/or other web tools thus making it available for public view conditional upon privacy requirements imposed by customer are incorporated. For example, if customer has provided contact details but no permission to make it public, customer comments will be excluded from public dashboard. Businesses may also choose to impose conditions that feedback software can use to vet and select the feedback from database before displaying it. In step 55, business entity finds that feedback of certain nature from a customer or customers can be shared with other customers or general public due to its usefulness. In step 56, business entity sets the sharing rules that can select feedback to be automatically shared using social media or other web tools. In step 57, business entity selects the social media and web tools to be used. A Dashboard is displayed with all feedback on social media tools that may include but not limited to Facebook and Twitter. Dashboard may be customized if the permissions for customization exist.

What is claimed is:

1. Method for allowing business entities to receive product and brand related input from customers through the use of internet connected mobile terminals, involving steps of: creation of a custom tag encoded with product related information; placing the custom tag on the product and related paraphernalia; customer opting to wirelessly extract the information from the custom tag using a browser run application on their mobile device; initiating the browser session using a session token generated by the authentication server; requesting geographical coordinates of the customer; comparing information extracted from custom tag and geographical coordinates with information stored in the authentication server for verification of customer's product purchase; upon verification based on set criteria, presenting the optimized customer identification and feedback page generated by a feedback server to the mobile device; capturing the feedback data entered by customer and storing it in feedback server; offering reward coupon generated by the rewards server to the customer after successful submission of the feedback form; updating the density map stored in the map server using the geographical coordinates provided; relaying the unprocessed and processed feedback data stored in feedback server and map data stored in map server to a dashboard in real-time; and displaying the relayed data in graphical format on the dashboard.

2. The method of claim 1, wherein the custom tag comprises at least one of a single tag, an array of tags working independently and an array of tags working in conjugation to present encoded information to the mobile device of the customer.

3. The method of claim 2, wherein the tag is at least one of a Quick Response code, a Near Field Communication chip and a printed machine readable shortened URL.

4. Method of claim 1, wherein custom tag is attached to the product and related paraphernalia in at least one of the ways of embedding in the product, attaching to the surface of the product, embedding in the package of the product, attaching to the surface of the product package, embedding in the documentation on the sale of the product, and attaching to the documentation on the sale of the product.

5. The method of claim 1, wherein information encoded in the custom tag is in the form of uniform resource locator containing information about product comprising product name, Universal Product Code, International Article Number, product code, batch and sale location.

6. The method of claim 1, wherein information encoded in the custom tag is in the form of uniform resource locator directing browser of customer's mobile device to a remotely stored file capable of transporting and storing data comprising of product name, Universal Product Code, International Article Number, product code, batch and sale location.

7. The method of claim 1, wherein the authentication server, feedback server, map server and rewards server comprise of computer software programs capable of reading, analysing and updating databases that run on at least one of the networked computers hosted in the business premises and the networked remote computer systems hosted on the cloud system.

8. The method of claim 1, wherein the authentication server comprises of a database comprising at least one of the product details of product name, Universal Product Code, International Article Number, product code, batch, sale location, and sale status obtained from inventory management system of the corresponding retailer.

9. The method of claim 1, wherein the feedback server comprise of two databases; first database comprising of all the feedback posts and the metadata connecting the posts to registered or unregistered customers; and second database comprising of profiles of customers who chose to register as remote product and brand consultant.

10. The method of claim 9, wherein the profile comprises of a unique identifying code, personal information, the feedback history and the reputation rating.

11. The method of claim 10, wherein the personal information comprises of the name, contact information, residence location and personal preferences of the customer as provided and verified during the registration process.

12. The method of claim 10, wherein the feedback history constitutes of product information as extracted from custom tag of the product during each feedback session, results of the verification conducted by authentication server during each feedback session, geographical location coordinates as captured during each feedback session, and the feedback in form of the answers to questions in the feedback form of feedback software module.

13. The method of claim 1, wherein the verification of the customer is conducted by the authentication server by comparing the acquired product information and location of the customer's mobile device with the product information stored in the database of authentication server wherein the results of match are categorized as one of the full match of product and location information, partial match with product information matching but location information not matching, and no match for product information.

14. The method of claim 1, wherein the map server comprises of a database comprising of latitude and longitude data of feedback providers location, and a software module capable of generating density maps utilizing data in the map server database and the two databases from the feedback server.

15. The method of claim 14, wherein the density map comprises of a map with visual depiction of the customer density in multitude of geographical regions as determined by latitude and longitude data of the feedback provider's location, overlaid with related feedback data and profile information.

16. The method of claim 1, wherein processed data displayed on the dashboard is obtained from Customer Relationship Management software and Analytics software tool capable of processing data stored in authentication server, feedback server, map server and rewards server.

17. The method of claim 1, wherein the feedback can be relayed to a dashboard linked to social media and other web tools thus making it available for public view conditional upon privacy requirements imposed by feedback provider.

18. The method of claim 17, wherein the feedback can be filtered based on business defined criteria before displaying on the dashboard linked to social media or other web tools.

19. A feedback software module capable of: establishing a communication session with mobile device of the said customer; extracting and interpreting information encoded in the custom tag of the product; initiating a browser session using a session token generated by the authentication server; requesting geographical coordinates of the said customer; comparing information extracted from custom tags and the supplied geographical coordinates with the product information stored in the authentication server for verification of customer's product purchase; presenting the optimized identification page generated by feedback server to the mobile device; presenting appropriate feedback page generated by a feedback server to the mobile device dependent on the identification option selected by customer in previous step; capturing the feedback data entered by customer and storing it in feedback server, offering reward coupon generated by the rewards server to the customer after successful submission of the feedback form; updating the density map stored in the map server using the geographical coordinates obtained earlier; processing and relaying the feedback data stored in feedback server and density map stored in map server to a dashboard in real-time; and displaying the relayed data in graphical format on the dashboard.

20. The module of claim 19, wherein the identification page provides customer an option to identify as one of the registered customer and unregistered customer.

21. The module of claim 19, wherein registered customers prove their identity by utilizing at least one of the methods of unique identifier assigned during registration, single sign-on using third-party application programming interface for login as set up during registration, and integrated login of existing third-party application set up during registration.

22. The module of claim 19, wherein the unregistered customers are presented with option to register as a product and brand consultant.
